(19) United States
(12) Patent Application Publication
(10) Pub. No.: US 2025/0125503 A1
(43) Pub. Date: Apr. 17, 2025

(54) METHOD FOR PRODUCING A POWER STORAGE DEVICE

(71) Applicant: Prime Planet Energy & Solutions, Inc., Tokyo (JP)

(72) Inventor: Katsuya SHIKATA, Nisshin-shi (JP)

(21) Appl. No.: 18/803,942

(22) Filed: Aug. 14, 2024

(30) Foreign Application Priority Data
Oct. 11, 2023 (JP) 2023-175969

(51) Int. Cl. H01M 50/536; H01M 10/04

(52) U.S. Cl. CPC H01M 50/536; H01M 10/0468

(57) ABSTRACT

In a method for producing a power storage device, the power storage device includes: an electrode body that housed in a case and configured such that a positive electrode body and a negative electrode body, each having an active-material coated part and an active-material uncoated part on an electrode foil, are stacked by interposing a separator therebetween; and the current collector terminal including a base portion connected to a long-side-direction end portion of the case and a lead portion bonded to the active-material uncoated part in an overlapped state. The method includes preliminarily bending the active-material uncoated part into an overlapped state to create a fold at a boundary area KR with the active-material coated part and then releasing the active-material uncoated part, and, following the preliminary bending step, bonding the active-material uncoated part to the lead portion while bending the active-material uncoated part again.

### CROSS-REFERENCE TO RELATED APPLICATIONS

This application is based upon and claims the benefit of priority to Japanese Patent Application No. 2023-175969 filed on Oct. 11, 2023, the entire contents of which are incorporated herein by reference.

### BACKGROUND

### Technical Field

The disclosure relates to a method for producing a power storage device, capable of reducing positional displacement of a current collector terminal bonded to an electrode body and suppressing warpage deformation of a sealing member to which the current collector terminal is connected.

### Related Art

Conventionally, when bonding a current collector terminal to laminated portions of an electrode foil or electrode foils of a stacked electrode body at an end portion in an axial direction, which are active-material uncoated parts, the current collector terminal and the laminated portions are often pressed together by a bonding tool (for example, a welding tip or ultrasonic horn) to bond the laminated portions to the current collector terminal (e.g., by resistance welding or ultrasonic welding), while overlapping the laminated portions into contact with each other. In such a case, the current collector terminal may slide or slip on the electrode foil in the process of overlapping the laminated portions into contact with each other, which causes positional displacement of a bonding portion of the current collector terminal in the axial direction (the lateral direction) of the electrode body. Consequently, a long case, which houses the electrode body and to which the current collector terminal is connected, is liable to cause warpage deformation in which a central part of the case in its longitudinal direction is deformed in the top-bottom direction. This results in deterioration in measurement accuracy of a temperature sensor for monitoring the temperature of a battery, i.e., the power storage device, by contacting the top surface of case, for example.

In this regard, for example, Japanese unexamined patent application publication No. 2014-022203 (JP2014-022203A) discloses a terminal bonding method in which, when bonding an electrode foil and a current collector terminal, portions of the electrode foil located close to an active-material coated part of the electrode body relative to bonded portions of the electrode foil are pressed by a presser from both sides in the lamination direction preliminarily into an overlapped state, and then the electrode foil and the current collector terminal are bonded. In this terminal bonding method, however, the portions of the electrode foil are overlapped in advance, which will unlikely cause a problem that the bonding portion of the current collector terminal is displaced from a proper position in the axial direction. This can suppress warpage deformation of the case to which the current collector terminal is connected and, for example, improve the measurement accuracy of the temperature sensor placed in contact with the top surface of the case.

### SUMMARY

### Technical Problems

However, in the above configuration in which the overlapped portions of the electrode foil, located close to the active-material coated part relative to the bonded portions of the foil bonded to the current collector terminal, are pressed by the presser from both sides in the lamination direction, the bonded portions of the foil have to be formed at a position where the bonding tool does not interfere with the presser. Accordingly, the bonded portions of the foil must be extended in a direction away from the active-material coated part of the electrode body. This is undesirable because the case volume is increased, leading to a decrease in the power storage capacity per unit volume of the case.

The present disclosure has been made to address the above problems and has a purpose to provide a method for producing a power storage device, capable of reducing positional displacement of a current collector terminal in the process of bonding an electrode foil and the current collector terminal to suppress warpage deformation of a case to which the current collector terminal is connected, while enhancing the power storage capacity per case unit volume.

### Means of Solving the Problems

(1) To achieve the above-mentioned purpose, one aspect of the present disclosure provides a method for producing a power storage device comprising: a case; an electrode body housed in the case, the electrode body including a positive electrode body and a negative electrode body, which are stacked with a separator interposed therebetween, each of the positive electrode body and the negative electrode body including an active-material coated part made of a part of an electrode foil, coated with active material, and an active-material uncoated part made of a part of the electrode foil, uncoated with active material in one end portion of the electrode foil, the active-material coated part and the active-material uncoated part being located opposite each other in a long-side direction of the case; and positive and negative current collector terminals, each including: a base portion connected to either end portion of the case in the long-side direction via an insulating member; and a lead portion bonded to the active-material uncoated part in an overlapped state, wherein the method comprises: preliminarily bending the active-material uncoated part into the overlapped state to create a fold in the active-material uncoated part at a boundary area with the active-material coated part, and then releasing the active-material uncoated part; and after preliminarily bending, bonding the lead portion to the active-material uncoated part while bending the active-material uncoated part again into the overlapped state.

(2) In the method for producing a power storage device described in (1), preliminarily bending the active-material uncoated part may comprise bending the active-material uncoated part several times into the overlapped state.

### BRIEF DESCRIPTION OF THE DRAWINGS

FIG. 1 is a schematic cross-sectional view of a power storage device produced by a production method in one aspect of an embodiment;

FIG. 2 is a schematic perspective view of an electrode body shown in FIG. 1, showing a state where a positive electrode body and a negative electrode body are in the course of being wound with separators interposed therebetween;

FIG. 3 is a cross-sectional view taken along a line A-A in FIG. 1;

FIG. 4 is an enlarged cross-sectional view of a part B in FIG. 1;

FIG. 5 is a flowchart showing a method for producing the power storage device shown in FIG. 1;

FIG. 6A is a schematic cross-sectional view taken along a line C-C in FIG. 4, showing a stacked state of an electrode body before being subjected to a preliminary bending step shown in FIG. 5;

FIG. 6B is a schematic cross-sectional view showing that an active-material uncoated part shown in FIG. 6A is bent into an overlapped state to create a fold in the active-material uncoated part at a boundary area with the active-material coated part;

FIG. 6C is a schematic cross-sectional view showing that the active-material uncoated part shown in FIG. 6B is released from the overlapped state;

FIG. 7A is a schematic cross-sectional view showing that a current collector terminal is placed on the active-material uncoated part shown in FIG. 6C;

FIG. 7B is a schematic cross-sectional view showing that the active-material uncoated part shown in FIG. 7A is bent again into an overlapped state to bond to the current collector terminal;

FIG. 7C is a schematic cross-sectional view showing that the active-material uncoated part shown in FIG. 7B and the current collector terminal are completely bonded to each other; and

FIG. 8 is a schematic cross-sectional view showing that the current collector terminal is in the course of being bonded to the active-material uncoated part while the active-material uncoated part is overlapped by a bonding jig that pressurizes the current collector terminal and the active-material uncoated part together in a method for producing a power storage device in a comparative example.

### DETAILED DESCRIPTION OF THE EXEMPLARY EMBODIMENTS

### <Configuration of Power Storage Device>

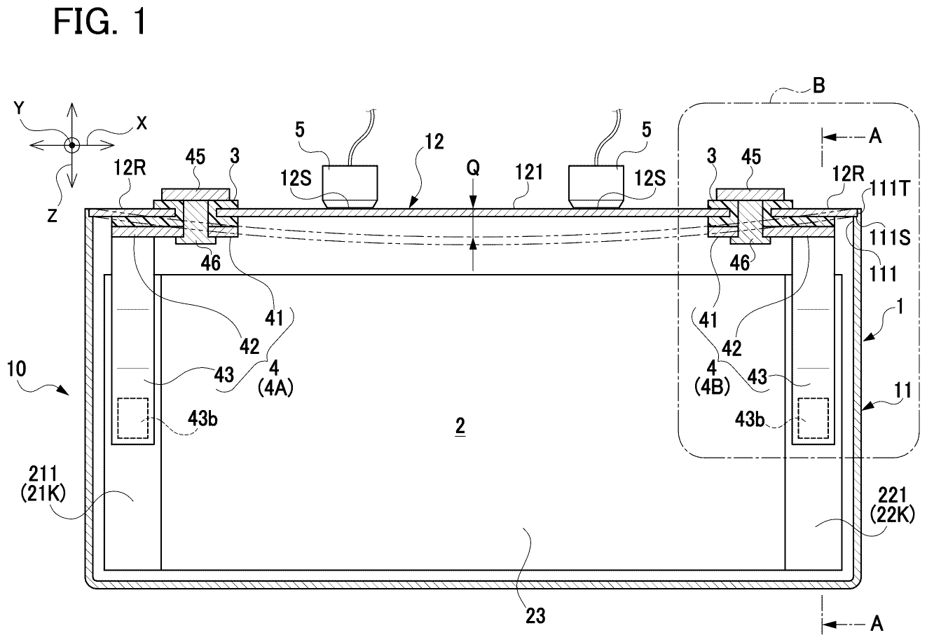

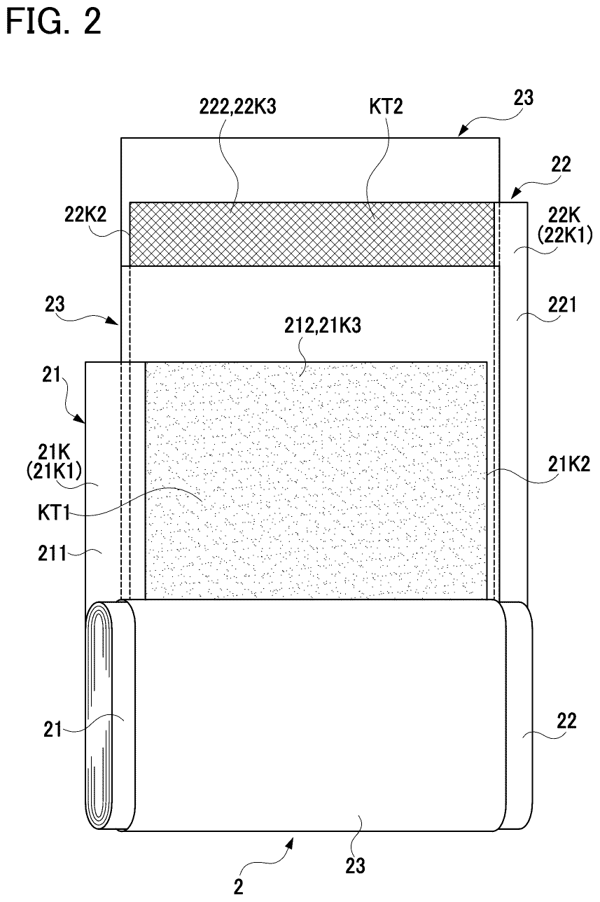

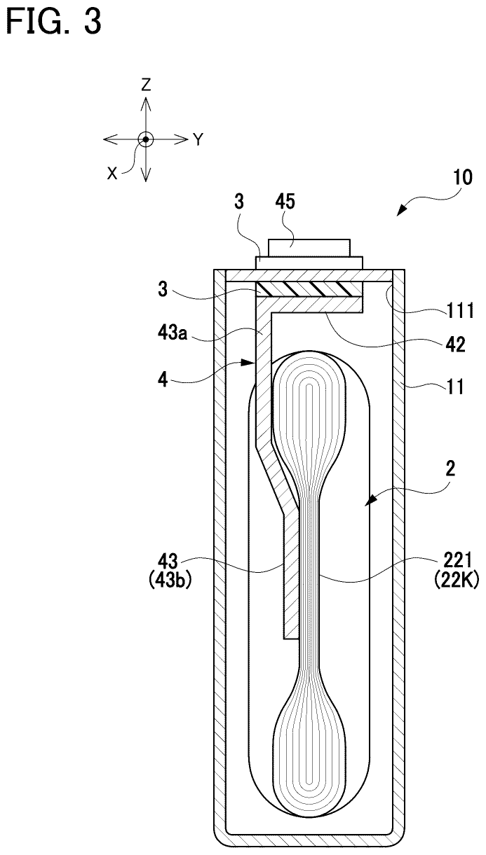

A detailed description of a power storage device produced by the production method in the embodiment of the disclosure will now be given referring to the accompanying drawings. FIG. 1 is a schematic cross-sectional view of the power storage device produced by the production method in one aspect of the embodiment. FIG. 2 is a schematic perspective view of an electrode body shown in FIG. 1, showing a state where a positive electrode body and a negative electrode body are in the course of being wound with separators interposed therebetween. FIG. 3 is a cross-sectional view taken along a line A-A in FIG. 1. In FIG. 1 and FIG. 3, the direction X indicates the long-side direction of a sealing member, the direction Y indicates the short-side direction of the same, and the direction Z indicates the top-bottom direction of a case.

The power storage device 10 produced by the production method in the embodiment of the disclosure includes a case 1, an electrode body 2, and current collector terminals 4, as shown in FIG. 1 to FIG. 3. In this embodiment, the case 1 includes a case body 11 having a bottomed rectangular prismatic shape with a rectangular opening portion 111, and a sealing member 12 having a long flat plate-like shape closing the opening portion 111. The case body 11 and the sealing member 12 are each made of aluminum. The sealing member 12, which is a lid member of the power storage device 10 in this embodiment, is required to enhance the opening performance of a safety valve not shown and thus is made of especially a material that is softer and more deformable than the current collector terminals 4. The shape of the case 1 is not limited to the above one.

The opening portion 111 of the case body 11 is formed with a thinned portion 111T in only the inner wall on each short side. Therefore, end portions 12R of the sealing member 12 at both ends in the long-side direction, i.e., the X-direction, are supported on shoulders 111S formed at lower ends of the thinned portions 111T. However, the opening portion 111 of the case body 11 has no thinned portions in the inner wall on each long side and thus cannot stop a central part of the sealing member 12 from causing displacement, e.g., warpage deformation, in the top-bottom direction, i.e., the Z-direction. Further, on an upper surface 121 of the case 1 (i.e., the sealing member 12), a sensor contact surface 12S is provided to allow contact with a temperature sensor 5 for monitoring the temperature of the power storage device 10.

The electrode body 2 is formed of a positive electrode body 21 and a negative electrode body 22, which are stacked with separators 23 interposed therebetween, and is housed in the case 1. The positive electrode body 21 includes an active-material uncoated part 211 in which one end portion 21K1 of an electrode foil 21K (i.e., the left end area in FIG. 2) is not coated with active material KT1 and an active-material coated part 212 in which the electrode foil 21K is coated with active material KT1. Similarly, the negative electrode body 22 includes an active-material uncoated part 221 in which one end portion 22K1 of an electrode foil 22K (i.e., the right end area in FIG. 2) is not coated with active material KT2, and an active-material coated part 222 in which the foil 22K is coated with active material KT2. The active-material uncoated part 211 of the positive electrode body 21 and the active-material uncoated part 221 of the negative electrode body 22 are located opposite each other in the long-side direction of the sealing member 12, i.e., the X-direction. The active-material coated part 212 is formed over the other end portion 21K2 and a middle portion 21K3 of the electrode foil 22K. The active-material coated part 222 is formed over the other end portion 22K2 and a middle portion 22K3 of the electrode foil 22K. Herein, the electrode body 2 is formed by winding the positive electrode body 21 and negative electrode body 22 with the separators 23 interposed therebetween into a flat shape. As an alternative, the electrode body 2 may be formed by alternately stacking sheet-shaped positive electrode bodies 21 and sheet-shaped negative electrode bodies 22 with separators 23 interposed between adjacent positive and negative electrode sheets 21 and 22 into a flat shape.

The power storage device 10 in this embodiment refers to all power storage devices that can generate electric energy to be extracted, and may include for example primary batteries, secondary batteries, electric double layer capacitors, and so on. For example, in a lithium ion secondary battery, the electrode foil 21K of the positive electrode body 21 may be for example an aluminum foil, and carry thereon the active material KT1 made of e.g. lithium transition metal oxide (LiNi_{1/3}Co_{1/3}Mn_{1/3}O₂, LiNiO₂, etc.). Further, the electrode foil 22K of the negative electrode body 22 may be for example a copper foil, and carry thereon the active material KT2 made of e.g. black carbon, hard carbon, soft carbon, etc. The separator 23 may be a porous sheet, made of e.g. polypropylene, polyethylene, etc. The electrolyte contained in the power storage device 10 may be a well-known non-aqueous electrolyte.

Of the current collector terminals 4, a current collector terminal 4A for positive electrode is made of e.g. aluminum and a current collector terminal 4B for negative electrode is made of e.g. copper. Each of the positive and negative current collector terminals 4 (4A, 4B) includes a base portion 41, a base adjoining portion 42, and a lead portion 43, which are integrally formed. The base portion 41 is connected to the back surface of an end portion 12R of the sealing member 12 at each end in the long-side direction, i.e., the X-direction, via an insulating member 3. The base adjoining portion 42 is located adjacent to the base portion 41, and separated from or separably in contact with the insulating member 3. The lead portion 43 includes a lead upper end portion 43a on the upper side of the case 1, which is bent from the base adjoining portion 42 in a downward direction of the case 1, i.e., the Z-direction, and a lead lower end portion 43b on the lower side of the case 1. The lead lower end portion 43b of the current collector terminal 4A is bonded by welding to the active-material uncoated part 211 of the electrode body 2, in which uncoated portions of the electrode foil 21K are in an overlapped, or pressed, state, that is, a collected foil state. Similarly, the lead lower end portion 43b of the current collector terminal 4B is bonded by welding to the active-material uncoated part 221 of the electrode body 2, in which uncoated portions of the electrode foil 22K are in an overlapped, or pressed, state, that is, a collected foil state.

The base portion 41 is connected to an external connection part 45 located on the top surface of the sealing member 12 with a swaged pin 46 or the like, for example. The insulating member 3 is also interposed between the swaged pin 46 and the sealing member 12 and also between the external connection part 45 and the sealing member 12. The insulating member 3 may be made of for example polyphenylene sulfide (PPS). The external connection part 45 is connectable to a busbar (not shown) for connection of two or more power storage devices 10.

During welding bonding of the electrode body 2 and the lead lower end portion 43b of each current collector terminal 4, the external force is apt to occur, causing the lead lower end portion 43b to slide on the uncoated portions of the electrode foil 21K (22K) that are in the process of being collected together, and to be displaced in the long-side direction of the sealing member 12, i.e., the X-direction. Reducing this external force can effectively suppress warpage deformation of the sealing member 12 (i.e., the case 1) with the end portions 12R at both ends in the long-side direction being connected respectively to the base portions 41, that is, suppress the central part of the sealing member 12 (i.e., the case 1) in the long-side direction from being displaced in the top-bottom direction, i.e., the Z-direction. Consequently, the temperature sensor 5 is allowed to properly contact the sensor contact surface 12S of the upper surface 121 of the sealing member 12 (the case 1), and hence the measurement accuracy of this temperature sensor 5 can be improved.

The following description will be given to a method for producing the power storage device 10, capable of reducing the external force that causes the lead lower end portion 43b of each current collector terminal 4 to be displaced in the long-side direction of the sealing member 12 (the case 1), i.e., the X-direction, during welding bonding of the electrode body 2 and each lead lower end portion 43b.

### Method for Producing the Power Storage Device

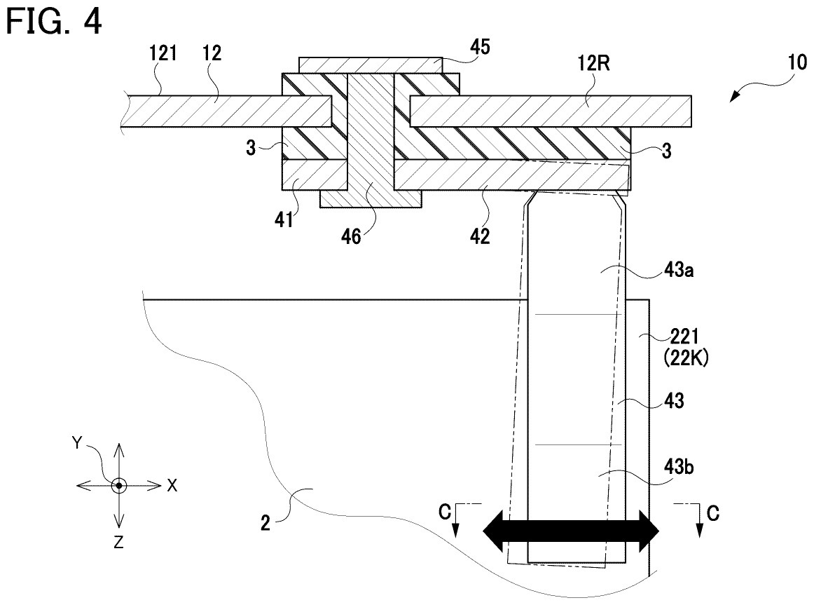

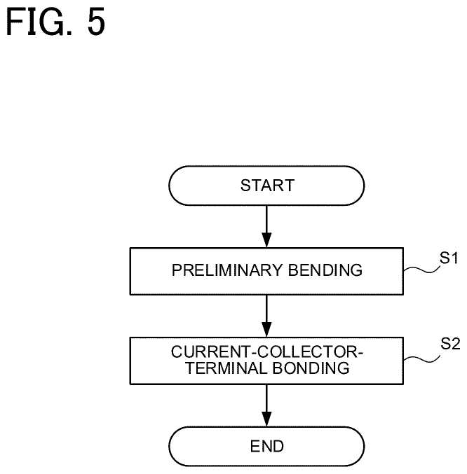

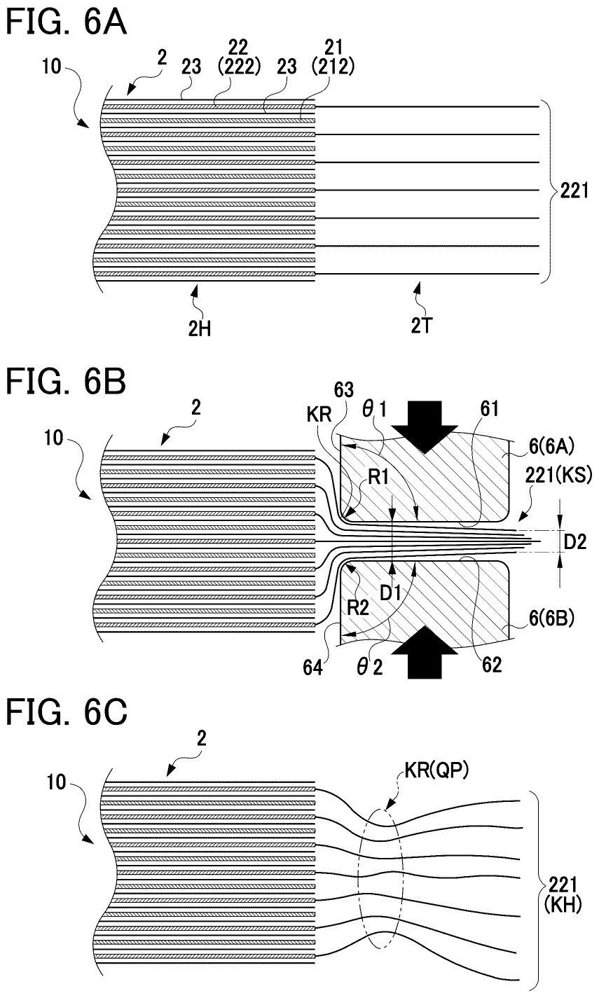

The method for producing the foregoing power storage device 10 in the embodiment of the disclosure will be described in detail below, referring to accompanying drawings. FIG. 4 is an enlarged cross-sectional view of a part B in FIG. 1. FIG. 5 is a flowchart showing the production method for the power storage device 10 shown in FIG. 1. FIG. 6A is a schematic cross-sectional view taken along a line C-C in FIG. 4, showing a stacked state of the electrode body 2 before being subjected to a preliminary bending step shown in FIG. 5.

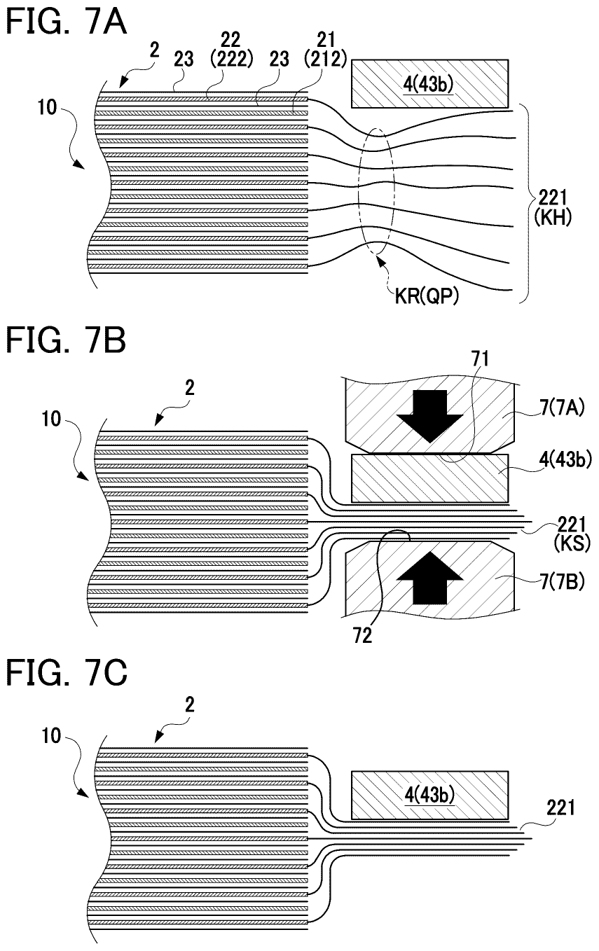

The method for producing the power storage device 10 includes a preliminary bending step S1 and a current-collector-terminal bonding step S2, as shown in FIG. 5. Herein, as shown in FIG. 6A, the electrode body 2 before being subjected to the preliminary bending step S1 includes an electrode-body main portion 2H extending straight, in which the separator 23, the active-material coated part 222 of the negative electrode body 22, the separator 23, and the active-material coated part 212 of the positive electrode body 21 are stacked one on another, and an electrode-body end portion 2T extending straight, in which the active-material uncoated part 221 of the negative electrode body 22 is formed in layers spaced with gaps. An electrode-body end portion (not shown) of the positive electrode body 21 is located opposite the electrode-body end portion 2T of the negative electrode body 22 in the long-side direction of the sealing member 12 (the case 1), in which the active-material uncoated part 211 of the positive electrode body 21 is also formed in layers spaced with gaps and extends straight. This active-material uncoated part 211 is not illustrated in FIGS. 6A to 6C and 7A to 7C, but its configuration is similar to the active-material uncoated part 221, and therefore the active-material uncoated part will be described hereinafter with the referential signs “211, 221” for convenience.

FIG. 6B is a schematic cross-sectional view showing that the active-material uncoated part shown in FIG. 6A is bent into an overlapped, or pressed, state to create a fold in the active-material uncoated part at a boundary area with the active-material coated part. FIG. 6C is a schematic cross-sectional view showing that the active-material uncoated part shown in FIG. 6B is released from the overlapped state.

In the preliminary bending step S1, as shown in FIG. 6B, the active-material uncoated part 211, 221 is bent into an overlapped state KS with a pressing jig 6 to create a fold QP in the active-material uncoated part 211, 221 at the boundary area KR with the active-material coated part 212, 222. Then, the active-material uncoated part 211, 221 is released from the overlapped state, as shown in FIG. 6C. The pressing jig 6 is provided with an upper presser 6A including a flat pressing surface 61 and a vertical wall surface 63 and a lower presser 6B similarly including a flat pressing surface 62 and a vertical wall surface 64. Those upper presser 6A and lower presser 6B pinch the active-material uncoated part 211, 221 from above and below, so that the corners R1 and R2 create the fold QP in the active-material uncoated part 211, 221 bent at the boundary area KR with the active-material coated part 212, 222.

The corner R1 has an intersecting angle θ1 between the pressing surface 61 and the vertical wall surface 63 and the corner R2 has an intersecting angle θ2 between the pressing surface 62 and the vertical wall surface 64. Each of these angles θ1 and 02 in the embodiment is a right angle, but may be an acute angle; for example, 80° or more but less than 90°. This is because the corners R1 and R2 formed with the acute intersecting angles θ1 and θ2 respectively can come into contact with the active-material uncoated part 211, 221 at the boundary area KR so that a larger bend can be made, making it easier to create the fold QP. When the corner R1 of the upper presser 6A and the corner R2 of the lower presser 6B are each formed in a rounded shape, the radius of the rounded shape may be less than 1 mm, and further about 0.4 to 0.6 mm. This is because the radius of 1 mm or more may cause the electrode foil 21K, 22K of the bent active-material uncoated part 211, 221 to spring back, resulting in the possibility that the fold QP could not be fully formed. Furthermore, a gap D1 between the pressing surfaces 61 and 62 when the upper presser 6A and the lower presser 6B firmly hold, or pinch, the active-material uncoated part 211, 221 from above and below may be slightly larger than the total plate (foil) thickness value D2 (e.g., about 0.1 to 3.0 mm) of the overlapped portions of the active-material uncoated part 211, 221.

After the fold QP is formed in the active-material uncoated part 211, 221 at the boundary area KR with the active-material coated part 212, 222, the active-material uncoated part 211, 221 is released as shown in FIG. 6C. When the active-material uncoated part 211, 221 is released once from its bent state, the active-material uncoated part 211, 221 attempts to return to its original state by its own elasticity. This can reduce residual tensile stress of the electrode foil 21K, 22K in the active-material uncoated part 211, 221, and hence reduce the possibility that the electrode foil 21K, 22K is torn or broken in a next current-collector-terminal bonding step S2. The active-material uncoated part 211, 221 in the released state KH springs back as it attempts to return to its original state, but the fold QP at the boundary area KR remains. The upper and lower laminated portions of the active-material uncoated part 211, 221 especially have a large fold QP left to a certain degree.

FIG. 7A is a schematic cross-sectional view showing that the current collector terminal is placed on the active-material uncoated part shown in FIG. 6C. FIG. 7B is a schematic cross-sectional view showing that the active-material uncoated part shown in FIG. 7A is bent again into an overlapped state to bond to the current collector terminal. FIG. 7C is a schematic cross-sectional view showing that the active-material uncoated part shown in FIG. 7B and the current collector terminal are completely bonded to each other.

In the current-collector-terminal bonding step S2, after the preliminary bending step S1, the lead portion 43 (i.e., the lead lower end portion 43b) of the current collector terminal 4 is placed in contact with the active-material uncoated part 211, 221 in the released state KH where the fold QP remains at the boundary area KR as shown in FIG. 7A, and then the active-material uncoated part 211, 221 is bent again into the overlapped state with a bonding jig 7 as shown in FIG. 7B to bond the lead lower end portion 43b to the active-material uncoated part 211, 221. The bonding jig 7 is provided with an upper pressurizing member 7A and a lower pressurizing member 7B respectively having pressurizing surfaces 71 and 72 for resistance welding or ultrasonic welding, for example. The upper pressurizing member 7A and the lower pressurizing member 7B are energized or ultrasonically vibrated while holding, or pinching, the lead lower end portion 43b and the active-material uncoated part 211, 221 from above and below in the overlapped state KS, to bond the active-material uncoated part 211, 221 and the lead portion 43 (i.e., the lead lower end portion 43b) by welding.

At that time, the active-material uncoated part 211 has the fold QP remaining at the boundary area KR with the active-material coated part 212, 222. Thus, when bending the active-material uncoated part 211, 221 again into the overlapped state KS, the upper pressurizing member 7A and the lower pressurizing member 7B can easily bend the active-material uncoated part 211, 221 from the fold QP as a starting point. This can reduce breakage of the active-material uncoated part 211, 221 and also can reduce the external force causing the lead lower end portion 43b to be displaced in the long-side direction of the case 1, i.e., the X-direction. Because of this reduction of external force, the displacement amount Q of the central part of the sealing member 12 (the case 1) in the long-side direction, to which the base portions 41 are connected at the end portions 12R, can be reduced in the top-bottom direction, i.e., the Z-direction, which further enhance the measurement accuracy of the temperature sensor 5 that monitors the temperature of the power storage device 10. Since the fold QP of the active-material uncoated part 211, 221 is formed at the boundary area KR with the active-material coated part 212, 222, the current collector terminal 4 can be bonded near the boundary area KR with the active-material coated part 212, 222 and thus the power storage capacity per unit volume of the case 1 can be improved.

Consequently, the embodiment can provide the method for producing the power storage device 10, capable of reducing positional displacement of the current collector terminal 4 in the process of bonding the electrode foil 21K, 22K and the current collector terminal 4 to suppress warpage deformation of the case 1 to which the current collector terminal 4 is bonded, while improving the power storage capacity per case unit volume.

In the method for producing the power storage device 10 in the embodiment, furthermore, the preliminary bending step S1 shown in FIG. 5 may be performed by bending the active-material uncoated part 211, 221 several times to form into the overlapped state KS. By bending the active-material uncoated part 211, 221 several times, the fold QP formed at the boundary area KR with the active-material coated part 212, 222 can remain more stably, in the current-collector-terminal bonding step S2 further enabling to reduce the external force that causes the lead lower end portion 43b to be displaced in the case long-side direction, i.e., the X-direction, and also suppress the active-material uncoated part 211, 221 from being broken or torn. This configuration can reduce the displacement amount Q of the long-side-direction central part of the sealing member 12 (the case 1), to which the base portions 41 are connected at the long-side-direction end portions 12R, in the top-bottom direction, i.e., the Z-direction, and can further enhance the measurement accuracy of the temperature sensor 5 that monitors the temperature of the power storage device 10.

In the preliminary bending step S1, when the active-material uncoated part 211, 221 is to be bent several times into the overlapped state KS, the gap D between the pressurizing surfaces 72 and 72 may be gradually decreased to gradually increase the bending angle of the active-material uncoated part 211, 221. This configuration can reduce local extension of the electrode foil 21K, 22K in the active-material uncoated part 211, 221, and hence avoid breakage of the electrode foil 21K, 22K more reliably.

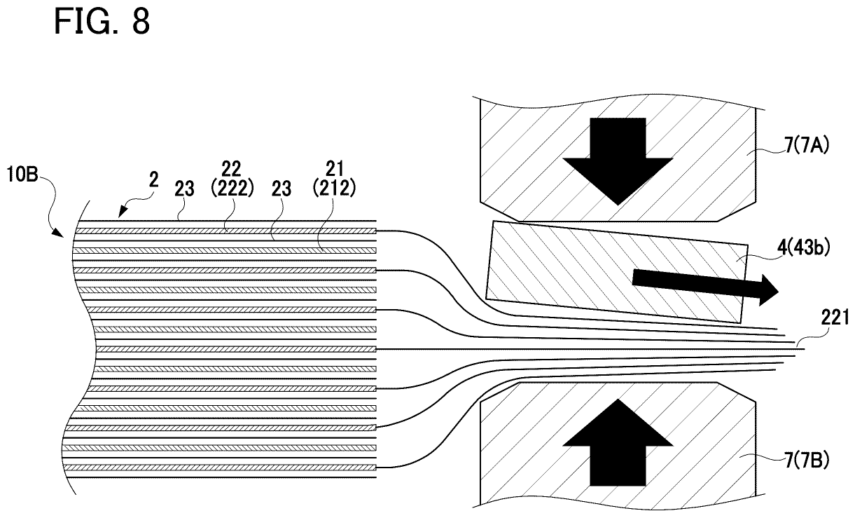

FIG. 8 is a schematic cross-sectional view showing that the current collector terminal 4 is in the course of being bonded to the active-material uncoated part 211, 221 while portions of the active-material uncoated part 211, 221 are being overlapped, or pressed, by the bonding jig 7 that pressurizes the current collector terminal 4 and the active-material uncoated part 211, 221 together in a method for producing a power storage device 10B in a comparative example. In this production method for the power storage device 10B in the comparative example, the lead lower end portion 43b of the current collector terminal 4 is apt to slide in the long-side direction of the sealing member 12 (the case 1), i.e., the X-direction with respect to the active-material uncoated part 211, 221 which is in the course of being bended, resulting in an increased positional displacement amount of the lead lower end portion 43b. This method is thus undesirable.

### Modified Example

The foregoing embodiments are mere examples and give no limitation to the present disclosure. The present disclosure may be embodied in other specific forms without departing from the essential characteristics thereof. For instance, the pressing jig 6 used in the preliminary bending step S1 is different from the bonding jig 7 used in the current-collector-terminal bonding step S2, but not limited thereto. As an alternative, the bonding jig 7 used in the current-collector-terminal bonding step S2 may also be used in the preliminary bending step S1 instead of the pressing jig 6.

### REFERENCE SIGNS LIST

1 Case
2 Electrode body
3 Insulating member
4, 4A, 4B Current collector terminal
10 Power storage device
21 Positive electrode body
22 Negative electrode body
23 Separator
21K, 22K Electrode foil
21K1, 22K1 One end portion
41 Base portion
43 Lead portion
43b Lead lower end portion
211, 221 Active-material uncoated part
212, 222 Active-material coated part
KR Boundary area
KT1, KT2 Active material
QP Fold
S1 Preliminary bending step
S2 Current-collector-terminal bonding step

What is claimed is:

1. A method for producing a power storage device comprising:
a case;
an electrode body housed in the case, the electrode body including a positive electrode body and a negative electrode body, which are stacked with a separator interposed therebetween,
each of the positive electrode body and the negative electrode body including an active-material coated part made of a part of an electrode foil, coated with active material, and an active-material uncoated part made of a part of the electrode foil, uncoated with active material in one end portion of the electrode foil, the active-material coated part and the active-material uncoated part being located opposite each other in a long-side direction of the case; and
positive and negative current collector terminals, each including:
a base portion connected to either end portion of the case in the long-side direction via an insulating member; and
a lead portion bonded to the active-material uncoated part in an overlapped state,
wherein the method comprises:
preliminarily bending the active-material uncoated part into the overlapped state to create a fold in the active-material uncoated part at a boundary area with the active-material coated part, and then releasing the active-material uncoated part; and
after preliminarily bending, bonding the lead portion to the active-material uncoated part while bending the active-material uncoated part again into the overlapped state.

2. The method for producing a power storage device, according to claim 1,
wherein preliminarily bending the active-material uncoated part comprises bending the active-material uncoated part several times into the overlapped state.
